(19) United States
(12) Patent Application Publication
(10) Pub. No.: US 2013/0009894 A1
(43) Pub. Date: Jan. 10, 2013

(54) TOUCH-SENSITIVE DISPLAY PANEL

(75) Inventors: Po-Hsien Wang, Taichung City (TW); Wen-Chun Wang, Taichung City (TW); Yung-Cheng Chang, Taichung City (TW)

(73) Assignees: WINTEK CORPORATION, Taichung City (TW); WINTEK (CHINA) TECHNOLOGY LTD., Dongguan City (CN)

(21) Appl. No.: 13/542,603

(22) Filed: Jul. 5, 2012

(30) Foreign Application Priority Data
Jul. 7, 2011 (TW) 100124102

(51) Int. Cl. G06F 3/041

(52) U.S. Cl. 345/173

(57) ABSTRACT

A touch-sensitive display panel including a first panel, a second panel and a spacer layer is provided. The first panel has a touch-sensitive area. The second panel, parallel to the first panel, has a display area correspondingly located below the touch-sensitive area. The spacer layer is disposed between the first panel and the second panel and includes a plurality of conductive spacers for electrically connecting the first panel and the second panel.

This application claims the benefit of Taiwan application Serial No. 100124102, filed Jul. 7, 2011, the subject matter of which is incorporated herein by reference.

### BACKGROUND OF THE INVENTION

1. Field of the Invention

The invention relates in general to a touch-sensitive display panel, and more particularly to a touch-sensitive display panel which uses internal conductive spacers to receive a touch signal or transmit a display signal.

2. Description of the Related Art

Ever since the development of the touch panel technology, the touch panel has gained a significant market share in the market of consumer electronic products. Currently, touch-sensitive display panels integrating touch and display functions, which may be used in portable consumer electronic products such as wireless communication mobile phone, notebook computer, tablet PC, digital camera, are already available in the market.

However, for most of the electronic products integrating touch function, the touch panel and the display panel are directly assembled together, and use respective signal line for transmitting the touch signal and the display signal. Consequently, additional space is required for the assembly and soldering of signal lines, extra costs for electronic elements are required, the thinning tendency cannot be achieved, and the assembly cost cannot be reduced.

### SUMMARY OF THE INVENTION

The invention is directed to a touch-sensitive display panel which uses internal conductive spacers for receiving touch signals or transmitting display signals, so as to reduce the space required for the assembly and soldering of signal lines as well as the cost of the electronic elements required by the control circuit.

According to one embodiment of the present invention, a touch-sensitive display panel including a first panel, a second panel and a spacer layer is provided. The first panel has a touch-sensitive area. The second panel, parallel to the first panel, has a display area correspondingly located below the touch-sensitive area. The spacer layer, disposed between the first panel and the second panel having a plurality of conductive spacers for electrically connecting the first panel and the second panel.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a cross-sectional diagram of a touch-sensitive display panel according to one embodiment of the invention;

FIG. 2 shows a schematic diagram of a first panel according to one embodiment;

FIGS. 3A and 3B respectively show a cross-sectional diagram of sensing electrodes according to one embodiment;

FIG. 4 shows a cross-sectional diagram of a touch-sensitive display panel according to one embodiment of the invention;

FIG. 5 shows a schematic diagram of a touch-sensitive display panel according to one embodiment of the invention; and

FIG. 6 shows a schematic diagram of a touch-sensitive display panel according to one embodiment of the invention.

### DETAILED DESCRIPTION OF THE INVENTION

According to the touch-sensitive display panel of the present embodiment, conductive spacers are made from conductive materials having the characteristics of high conductivity and low impedance and are assembled between a touch panel and a display panel. The conductive spacers receive a touch signal detected by the touch panel or transmit the outputted display signal to the display panel for allowing the user to perform touch operation via the display frame. In one embodiment, the conductive spacers are realized by a conductive adhesive containing an anisotropic conductive material. The anisotropic conductive material is such as carbon nanotubes, conductive polymers or metal particles vertically disposed between the touch panel and the display panel for receiving the touch signal or transmitting the display signal.

It is to be understood that the following embodiments are exemplary and explanatory only and are not restrictive of the disclosed embodiments as claimed.

### First Embodiment

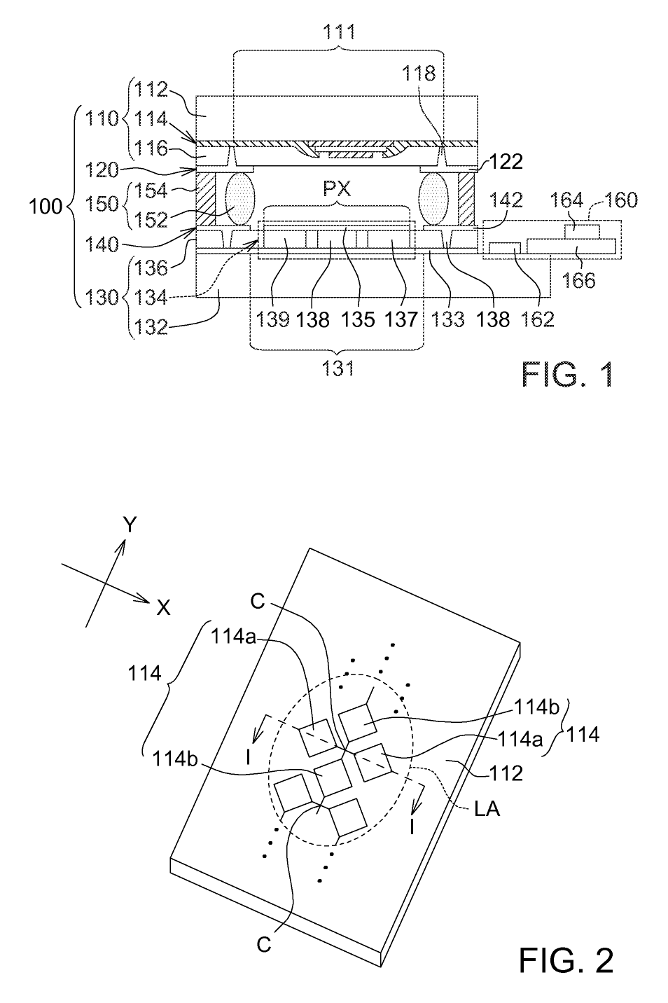

Referring to FIG. 1, a cross-sectional diagram of a touch-sensitive display panel according to one embodiment of the invention is shown. The touch-sensitive display panel 100 includes a first panel 110, a first conductive layer 120, a second panel 130, a second conductive layer 140 and a spacer layer 150. The first panel 110 has a touch-sensitive area 111. The first conductive layer 120 is disposed around the touch-sensitive area 111. The second panel 130, parallel to the first panel 110, has a display area 131. The display area 131 is correspondingly located below the touch-sensitive area 111. The second conductive layer 140 is disposed around the display area 131. The spacer layer 150, disposed between the first panel 110 and the second panel 130, includes a plurality of conductive spacers 152 for electrically connecting the first conductive layer 120 and the second conductive layer 140.

Referring to FIGS. 1 and 2. FIG. 2 shows a schematic diagram of a first panel according to one embodiment. The first panel 110 is such as a capacitive touch panel or resistive touch panel. Let the capacitive touch panel be taken for example. The first panel 110 includes a first substrate 112 and a plurality of sensing electrodes 114. The sensing electrodes 114 are disposed inside the touch-sensitive area 111 for detecting the coordinate position of a touch signal on two intersecting directions. In the enlarged area LA of FIG. 2, on the X-Y plane, a plurality of connected first electrode blocks 114a are disposed on the first substrate 112 along a first direction (such as the X-axis direction). Moreover, a plurality of connected second electrode blocks 114b are disposed on the first substrate 112 along a second direction (such as the Y-axis direction). The X-axis direction is perpendicular to Y-axis direction.

The electrode blocks 114a and the second electrode blocks 114b may be made from indium tin oxide (ITO), or other transparent conductive materials, such as cadmium tin oxide (CTO), zinc oxide aluminum (AZO), indium zinc oxide (IZO), zinc oxide (ZnO), tin oxide (SnO) or a combination thereof. In addition, the first substrate 112 may be a cover lens, and the part of the cover lens covering the first electrode blocks 114a and the second electrode blocks 114b is made from materials having the characteristics of high intensity, high transmittance, anti-scratching, such as glass, acrylic or engineering plastics.

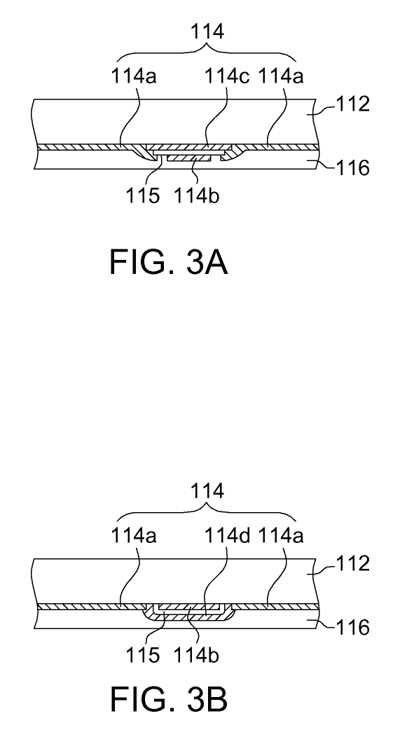

The first electrode blocks 114a and the second electrode blocks 114b may have any shapes such as square, rectangle, diamond, triangle, polygon, circle, oval-shaped. In the present embodiment, the shape of the electrode blocks is exemplified by diamond. Referring to FIGS. 3A and 3B, cross-sectional diagrams of sensing electrodes according to one embodiment are respectively shown. Let the sensing electrodes 114 along the cross-sectional line I-I of FIG. 2 be taken for example. The first electrode blocks 114a and the second electrode blocks 114b define the coordinate position of a touch signal on two intersecting directions (that is, the X coordinate position and the Y coordinate position). When the first electrode blocks 114a and the second electrode blocks 114b are disposed on the first substrate 112, an insulation material 115 may be disposed on the cross points C between the first electrode blocks 114a and the second electrode blocks 114b, so that one of the sensing electrodes crosses over another sensing electrode to avoid the short-circuiting between the first electrode blocks 114a and the second electrode blocks 114b.

FIG. 3A is different from FIG. 3B in that: in FIG. 3A, the conductive wire 114c is directly disposed on the cross points C of the sensing electrodes 114, and then the conductive wire 114c is partially covered by an insulation material 115. The adjacent first electrode blocks 114a are connected to the part of the conductive wire 114c not covered by the insulation material 115 to achieve electrical connection. The conductive wire of the second electrode blocks 114b crosses above the insulation material 115. As illustrated in FIG. 3B, the conductive wire of the second electrode blocks 114b on the cross points C is covered by an insulation material 115, the conductive wire 114d is disposed on the insulation material 115 and crosses over the insulation material 115 for electrically connecting the first electrode blocks 114a adjacent thereto. At last, the first sensing electrodes 114a, the second sensing electrodes 114b and the conductive wire 114d are covered by a passivation layer 116.

As indicated in FIG. 1, the first panel 110 includes a passivation layer 116 covering the sensing electrodes 114. Moreover, the passivation layer 116 includes a plurality of through holes 118, and the first conductive layer 120 is electrically connected to a corresponding sensing electrode 114 via one of the through holes 118. For example, the first electrode blocks 114a on the same X-axis direction may be electrically connected to a pad 122 (illustrated in FIG. 1) of the first conductive layer 120 via a corresponding first through hole 118 (illustrated in FIG. 1); the second electrode blocks 114b on the same Y-axis direction may be electrically connected to another pad (not illustrated) of the first conductive layer 120 via a corresponding second through hole (not illustrated).

Moreover, the second panel 130 is such as a liquid crystal display (LCD) panel or organic light emitting diode (OLED) display panel. The second panel 130 includes a second substrate 132 and a pixel array 134. The second substrate 132 may be a glass substrate, a plastic substrate or a flexible circuit board. The pixel array 134 is disposed on display area 131. For the liquid crystal display panel, the pixel array 134 includes a plurality of pixel switches (such as thin film transistors) arranged in the form of an array, signal lines (such as data lines and scan lines) and pixel electrodes for controlling the display of image pixels. For the OLED panel, the pixel array 134 includes an array formed by a plurality of pixel unit PX (only one is illustrated), wherein each pixel unit PX includes a plurality of organic light emitting diodes 137˜139 for controlling the display of image pixels.

The structure of the OLED panel is formed by such as but not limited to amorphous silicon thin film transistors (a-Si TFT), low-temperature poly-silicon transistors (LTPS TFT), organic transistors (organic TFT), metal oxide transistors (oxide TFT), or indium gallium zinc oxide transistors (IGZO TFT).

Furthermore, the second panel 130 includes an insulation layer 136 disposed around the pixel unit PX. The insulation layer 136 includes a plurality of through holes 138, and the second conductive layer 140 is electrically connected to a corresponding pixel unit PX via one of the through holes 138. For example, the lower electrode 133 of the pixel unit PX may be electrically connected to a pad 142 of the second conductive layer 140 (illustrated in FIG. 1) via a corresponding first through hole 138 (illustrated in FIG. 1); the upper electrode 135 of the pixel unit PX may be on the same or different layer with the second conductive layer 140. The signal required by the upper electrode 135 may be transmitted via the lower electrode 133, its corresponding first through holes 138, and the pad 142 of the second conductive layer 140 or directly controlled by the control circuit 160.

As indicated in FIG. 1, the touch-sensitive display panel 100 further includes a control circuit 160 disposed on second panel 130 or connected to the second panel 130 via a flexible circuit board 166. The conductive spacers 152 is disposed between the first panel 110 and the second panel 130 and is electrically connected between the first conductive layer 120 and the second conductive layer 140. Therefore, the touch signal detected by the first panel 110 may be transmitted to the second panel 130 via the conductive spacers 152. Then, the control circuit 160 determines the coordinate position of the touch signal on two mutually perpendicular directions so as to obtain the inputted instruction. Then, the control circuit 160 converts the inputted touch signal into a corresponding display signal, and further outputs the corresponding display signal to the second panel 130 for displaying a frame. Then, the user may perform touch operation via the display frame.

In one embodiment, the control circuit 160 includes a display driver 162, a touch signal processor 164 or a single chip 168 (illustrated in FIG. 5) formed by the display driver 162 and the touch signal processor 164. The use of the single chip 168 reduces the quantity of the electronic elements required by the control circuit 160, and the cost is reduced accordingly.

### Second Embodiment

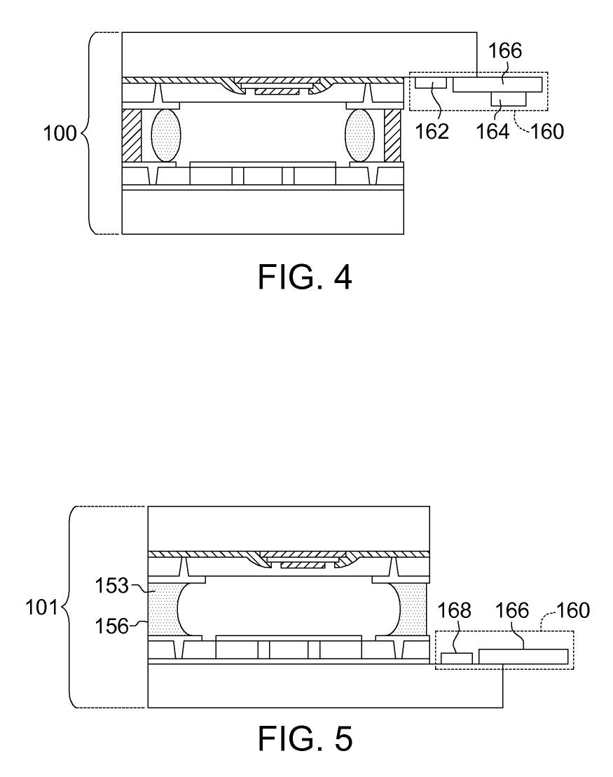

Referring to FIG. 4, a cross-sectional diagram of a touch-sensitive display panel according to one embodiment of the invention is shown. The present embodiment is different from the first embodiment in that: when the disposition space of the first panel 110 is larger than that of the second panel 130, the control circuit 160 is disposed on the first panel 110 or connected to the first panel 110 via a flexible circuit board 166. The conductive spacers 152 are disposed between the first panel 110 and the second panel 130 and are electrically connected between the first conductive layer 120 and the second conductive layer 140. Therefore, the control circuit 160 may directly receive the touch signal detected by the first panel 110 and further convert the inputted touch signal into a corresponding display signal, and output the display signal to the second panel 130 via the conductive spacers 152 for displaying a frame. Then, the user may perform touch operation via the display frame.

Detailed descriptions of the touch-sensitive display panel 100 are disclosed in the first embodiment, and are not repeated here.

### Third Embodiment

Referring to FIG. 5, a schematic diagram of a touch-sensitive display panel according to one embodiment of the invention is shown. In the first and the second embodiments, the spacer layer 150 includes a spacer wall 154 surrounding the touch-sensitive area 111 and being supported between the first panel 110 and the second panel 130 to form a plastic frame. Since the conductive spacers 152 and the spacer wall 154 are separated from each other, the spacer wall 154 may be realized by an insulating thermosetting adhesive, such as epoxy resin or acrylic resin. The present embodiment is different from the first and the second embodiments in that: the conductive spacers 152 and the spacer wall 154 are connected in one piece in the above embodiments. Meanwhile, for the spacer wall 154 and the conductive spacers 152, the conductive adhesive containing an anisotropic conductive material 153 is coated around the touch-sensitive display panel 101 to form a conductive frame 156.

The anisotropic conductive material 153 is such as carbon nanotubes, conductive polymers or metal particles vertically disposed between the touch panel and the display panel for receiving the touch signal or transmitting the display signal.

Detailed descriptions of the touch-sensitive display panel 101 are similar to the descriptions of the touch-sensitive display panel 100 of the first embodiment, and are not repeated here.

### Fourth Embodiment

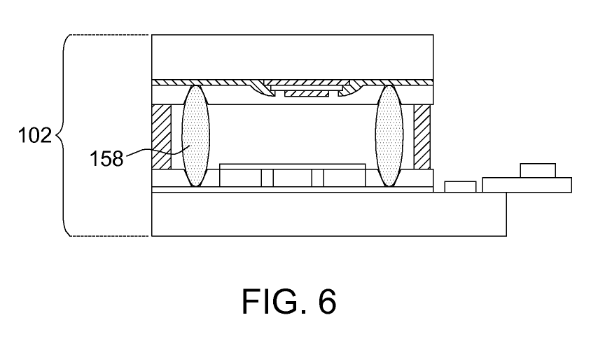

Referring to FIG. 6, a schematic diagram of a touch-sensitive display panel according to one embodiment of the invention is shown. In the first and the second embodiments, one end of the conductive spacers 152 is electrically connected to the first panel 110 via the first conductive layer 120, and another end of the conductive spacers 152 is electrically connected to the second panel 130 via the second conductive layer 140. The present embodiment is different from the first and the second embodiment in that: the conductive spacers 158 electrically connect the first panel 110 and the second panel 130 directly instead of going through the first conductive layer 120 and the second conductive layer 140. For example, the conductive spacers 158 may be electrically connected to corresponding sensing electrodes 114 for receiving a touch signal. In addition, the conductive spacers 158 may be electrically connected to the lower electrode 133 of a corresponding pixel unit 134 for transmitting the touch signal to the control circuit 160.

Detailed descriptions of the touch-sensitive display panel 102 are similar to the descriptions of the touch-sensitive display panel 100 of the first embodiment, and are not repeated here.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch-sensitive display panel, comprising:
a first panel having a touch-sensitive area;
a second panel parallel to the first panel and having a display area correspondingly located below the touch-sensitive area; and
a spacer layer disposed between the first panel and the second panel, wherein the spacer layer comprises a plurality of conductive spacers for electrically connecting the first panel and the second panel.

2. The touch-sensitive display panel according to claim 1, wherein the first panel comprises a first substrate and a plurality of sensing electrodes disposed inside the touch-sensitive area for detecting the coordinate position of a touch signal on two intersecting directions.

3. The touch-sensitive display panel according to claim 2, wherein the sensing electrodes comprise:
a plurality of connected first electrode blocks disposed on the first substrate along a first direction;
a plurality of connected second electrode blocks disposed on the first substrate along a second direction, wherein the second direction is perpendicular to the first direction; and
an insulation material disposed at the intersections between the first electrode blocks and the second electrode blocks.

4. The touch-sensitive display panel according to claim 2, further comprising a first conductive layer disposed around the touch-sensitive area and electrically connected to the conductive spacers.

5. The touch-sensitive display panel according to claim 4, wherein the first panel comprises a passivation layer covering the sensing electrodes, the passivation layer comprises a plurality of through holes, and the first conductive layer is electrically connected to corresponding sensing electrodes via one of the through holes.

6. The touch-sensitive display panel according to claim 1, wherein the second panel comprises a second substrate and a pixel array, the pixel array is disposed on the display area, and the pixel array comprises an array formed by a plurality of pixel units.

7. The touch-sensitive display panel according to claim 6, wherein each pixel unit comprises a plurality of organic light emitting diodes.

8. The touch-sensitive display panel according to claim 6, further comprising a second conductive layer disposed around the display area and electrically connected to the conductive spacers.

9. The touch-sensitive display panel according to claim 8, wherein the second panel comprises an insulation layer disposed around the pixel units, the insulation layer comprises a plurality of through holes, and the second conductive layer is electrically connected to corresponding pixel units via one of the through holes.

10. The touch-sensitive display panel according to claim 1, wherein the spacer layer comprises a spacer wall surrounding the touch-sensitive area and being supported between the first panel and the second panel.

11. The touch-sensitive display panel according to claim 10, wherein the conductive spacers and the spacer wall are separated from each other.

12. The touch-sensitive display panel according to claim 10, wherein the conductive spacers and the spacer wall are connected in one piece.

13. The touch-sensitive display panel according to claim 1, wherein the conductive spacers are a conductive adhesive containing an anisotropic conductive material.

14. The touch-sensitive display panel according to claim 1, further comprising a control circuit disposed on the first panel or the second panel for receiving a touch signal detected by the first panel and outputting a corresponding display signal to the second panel.

15. The touch-sensitive display panel according to claim 12, wherein the control circuit comprises a display driver, a touch signal processor or a single chip formed by the display driver and the touch signal processor.
